(19) United States
(12) Patent Application Publication
(10) Pub. No.: US 2002/0024035 A1
(43) Pub. Date: Feb. 28, 2002

(54) Dump valve for tank

(76) Inventors: Melvin B. Schellenberg, Lloydminster (CA); Murray G. Hozack, Marwayne (CA); Terrance D. Erickson, Lloydminster (CA); Jody E. Veltikold, Lloydminster (CA)

Correspondence Address: DAVIS & BUJOLD, P.L.L.C., 500 NORTH COMMERCIAL STREET, FOURTH FLOOR, MANCHESTER, NH, 03101, US

(21) Appl. No.: 09/929,134

(22) Filed: Aug. 14, 2001

(30) Foreign Application Priority Data
Aug. 23, 2000 (CA) 2,316, 589

(51) Int. Cl. F16K 51/00

(52) U.S. Cl. 251/144

(57) ABSTRACT

A dump valve for a tank includes a liquid retaining tank having a bottom. An outlet is positioned on the bottom of the tank. A valve seat is positioned on the outlet. The valve seat has inwardly tapered sidewalls. As liquid flows through the outlet, debris in the tank tends to wash down the tapered sidewalls of the valve seat. A valve member is provided which is movable between a closed position engaging the valve seat and an open position spaced from the valve seat. An actuator is provided to move the valve member between the closed position and the open position.

### FIELD OF THE INVENTION

The present invention relates to a dump valve for a tank and, in particular, a truck or trailer mounted transport tank used to haul oil.

### BACKGROUND OF THE INVENTION

Truck or trailer mounted transport tanks which are used to transport oil, have a dump valve positioned at the bottom of the tank. The valve consists of a valve plate which covers an outlet in the bottom of the tank. To unload the oil from the tanks, the trucks drive over a ground level inlet of an underground storage tank and open the valve. The valve is moved from a closed position to an open position, by turning a screw which retracts the valve plate, so it is spaced from the outlet of the tank. Problems are being experienced with these dump valve due to leakage problems. Debris tends to accumulate at the mouth of the outlet. When the plate moves to the closed position, this debris tends to hold up on corner of the plate, thereby enabling liquids to leak between the plate and the outlet. Any oil residue remaining in the tank, tends to leak onto the roadway as the truck pulls away after dumping its load of oil. If the leak remains undetected until the truck takes on another load of oil, the leakage problems from the full tank can be severe. The debris that causes the leakage problems is usually an accumulation of sand; as it is common for the oil to have a percentage of sand content. However, there are other types of debris that have been found to cause leakage problems, such as sticks and wire.

### SUMMARY OF THE INVENTION

What is required is a dump valve for a tank which is not as susceptible to being blocked by debris.

According to the present invention there is provided a dump valve for a tank which includes a liquid retaining tank having a bottom. An outlet is positioned on the bottom of the tank. A valve seat is positioned on the outlet. The valve seat has inwardly tapered sidewalls. As liquid flows through the outlet, debris in the tank tends to wash down the tapered sidewalls of the valve seat. A valve member is provided which is movable between a closed position engaging the valve seat and an open position spaced from the valve seat. An actuator is provided to move the valve member between the closed position and the open position.

The dump valve, as described above, greatly reduces any problems of leakage, as any debris tends to wash down the tapered sidewalls of the valve seat. It is preferred that the inwardly tapered sidewalls of the valve seat are at an angle of not less than 70 degrees and not more than 30 degrees. When the taper exceeds 30 degrees, the taper becomes too gradual and there is a danger that debris will build up on the surface of the taper instead of washing down the taper as intended. When the taper is less than 70 degrees, there is a danger that debris will build up around the upper edge and not wash down the taper as intended.

Although beneficial results may be obtained through the use of the dump valve, as described above, even more beneficial results may be obtained when the valve member has inwardly tapered sidewalls which mate with the inwardly tapered sidewalls of the valve seat. As the valve member mates with the valve seat, the inwardly tapered sidewalls of the valve member tend to push any debris down the inwardly tapered sidewalls of the valve seat. It is preferred that the valve member have a truncated conical engagement surface. A truncated conical engagement surface tends to have the desired inwardly tapered sidewalls.

Although beneficial results may be obtained through the use of the dump valve, as described above, there are some types of debris that may become suspended in the outlet and, as such, not be readily washed down the tapered sidewalls. For example, a string, a rope or wire, of sufficient length may have one end that is caught within the tank which results in the string, rope or wire becoming suspended in the outlet. Even more beneficial results may, therefore, be obtained when the valve member has a deformable engagement surface. Within limits, the deformable engagement surface deforms to form a liquid retaining seal with the inwardly tapered sidewalls of the valve seat notwithstanding the presence of debris.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a side elevation view, in section, of a tank equipped with a dump valve constructed in accordance with the teachings of the present invention.

FIG. 2 is a detailed side elevation view, in section, of the dump valve illustrated in FIG. 1, with the valve member in the open position.

FIG. 3 is a detailed side elevation view, in section, of the dump valve illustrated in FIG. 1, with the valve member in the closed position.

FIG. 4 is a top plan view of the dump valve illustrated in FIG. 1.

FIG. 5 is a detailed side elevation view, in section, of the dump valve illustrated in FIG. 1, with wire debris extending across the valve seat and the valve member in the closed position.

### DETAILED DESCRIPTION OF THE PREFERRED EMBODIMENT

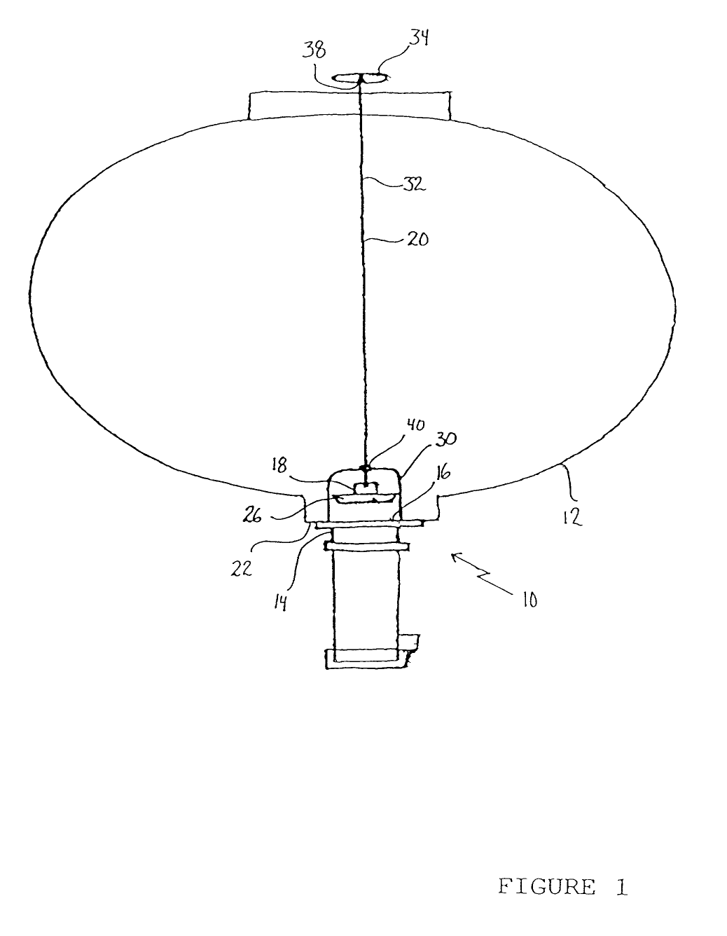

The preferred embodiment, a dump valve for a tank generally identified by reference numeral 10, will now be described with reference to FIGS. 1 through 5.

Structure and Relationship of Parts:

Referring to FIG. 1, there is provided a dump valve 10. Dump valve 10 is installed in a liquid retaining tank 12 having an outlet 14. The primary components of dump valve 10 include a valve seat 16, a valve member 18 and a screw actuator 20.

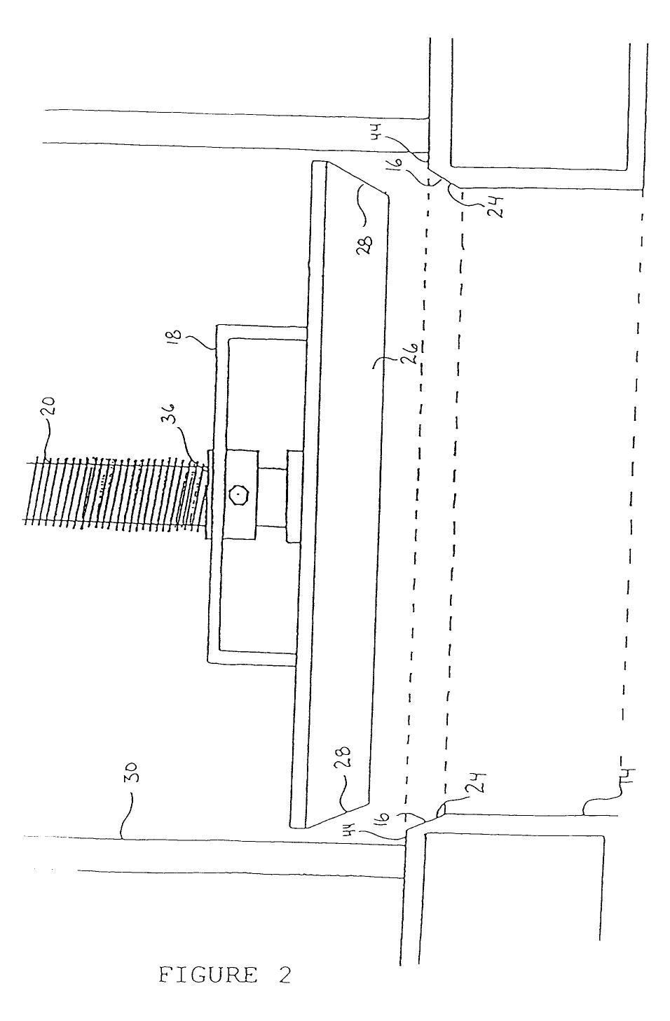

Tank 12 has a bottom 22 on which outlet 14 is positioned. Referring to FIG. 2, valve seat 16 is positioned on outlet 14. Valve seat 16 has inwardly tapered sidewalls 24 such that as liquid flows through outlet 14, debris in tank 12 tends to wash down tapered sidewalls 24 of valve seat 16. Inwardly tapered sidewalls 24 of valve seat 16 are at an angle of not less than 70 degree and not more than 30 degrees.

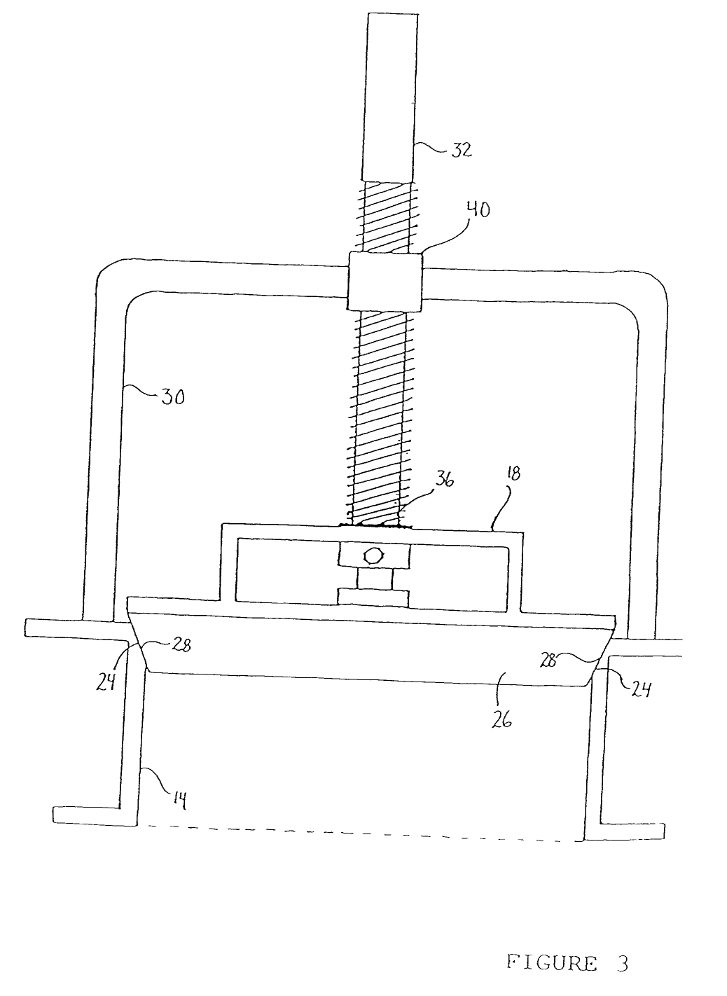

Referring to FIG. 3, valve member 18 has a deformable truncated conical engagement surface 26 with inwardly tapered sidewalls 28 which mate with inwardly tapered sidewalls 24 of valve seat 16 and deform to form a liquid retaining seal with inwardly tapered sidewalls 24 of valve seat 16 notwithstanding the presence of debris. A cage 30 surrounds valve seat 16 and valve member 18 and extends upward from bottom 22 of tank 12.

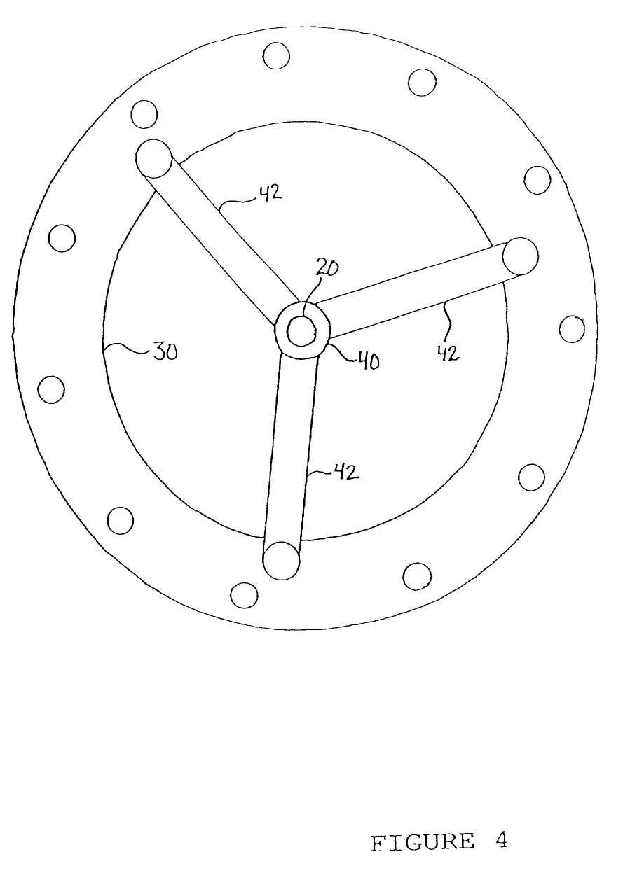

Referring to FIG. 1, screw actuator 20 includes a shaft 32 with a handle 34 for use in rotating shaft 32. Referring to FIG. 3, shaft 32 has a threaded first end 36 that is affixed to valve member 18. Referring to FIG. 1, handle 34 is affixed to a second end 38 of shaft 32. Screw actuator 20 extends vertically from valve member 18 up through a threaded collar 40 on cage 30. Referring to FIG. 3, threaded collar 40 is adapted to mate with threaded first end 36 of shaft 32 of screw actuator 20. Referring to FIG. 4, threaded collar 40 is supported by three support arms 42 of cage 30 which extend radially from threaded collar 40.

Rotation of screw actuator 20 in a first direction causes valve member 18 to move into a closed position engaging valve seat 16, while rotation of screw actuator 20 in a second direction causes valve member 18 to retract into an open position spaced from valve seat 16 as illustrated in FIG. 2. Referring to FIG. 1, cage 30 limits the movement of valve member 18, when in the open position.

Operation:

The use and operation of a dump valve 10 will now be described with reference to FIGS. 1 through 5. Referring to FIG. 1, when a truck or trailer mounted transport tank 12 is used to transport a liquid such as oil, it may be fitted with a dump valve 10 as described above. Referring to FIG. 3, while tank 12 is filled with a liquid, dump valve 10 is maintained in the closed position so that liquid does not exit tank 12. Referring to FIG. 2, when it is necessary to drain liquid from tank 12, dump valve 10 is moved from a closed position to an open position by turning screw actuator 20. Turning of screw actuator 20 retracts valve member 18 away from valve seat 16 so as to provide a space where liquid may exit through outlet 14. As liquid flows through outlet 14, debris in tank 12 tends to wash down tapered sidewalls 24 of valve seat 16. It is preferred that inwardly tapered sidewalls 24 of valve seat 16 are at an angle of not less than 70 degrees otherwise there is a danger that debris will build up around the upper edge 44 of tapered sidewalls 24 rather than wash down tapered sidewalls 24 as intended. Furthermore, it is also preferred that inwardly tapered sidewalls 24 of valve seat 16 are not more than 30 degrees otherwise the taper is too gradual and there is a danger that debris will build up on the surface of inwardly tapered sidewall 24 instead of washing down inwardly tapered sidewall 24. Referring to FIG. 3, after liquid has been drained from tank 12, screw actuator 20 is turned so as to return valve member 18 to the closed position. As inwardly tapered sidewalls 28 of valve member 18 meet with inwardly tapered sidewalls 24 of valve seat 16, inwardly tapered sidewalls 28 of valve member 18 tend to push any remaining debris down inwardly tapered sidewalls 24 of valve seat 16, so that debris will not remain and enable a leak to form when valve member 18 is returned to the closed position.

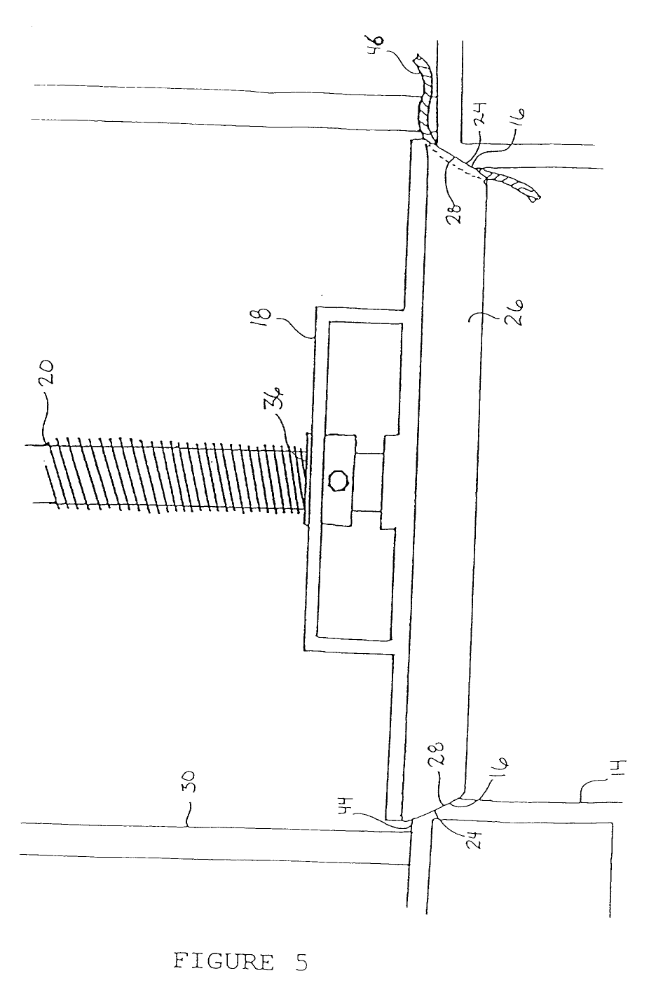

Referring to FIG. 5, there are instances where certain types of debris 46 such as string, wire or rope of a sufficient length become caught in tank 12 which result in debris 46 becoming suspended in outlet 14 rather than washed down outlet 14. In these instances, deformable engagement surface 26 is able to deform to accommodate debris 46 and form a liquid retaining seal with inwardly tapered sidewalls 24 of valve seat 16 notwithstanding debris 46 caught in-between.

There are different ways to provide valve member 18 with deformable engagement surface 26. Although valve member 18 could be covered by a rubber or elastomer coating, it is preferred that deformable engagement surface 26 be secured by fasteners so as to be detachable to facilitate both installation and replacement.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

The embodiment of the invention in which an exclusive property or privilege is claimed are defined as follows:

1. A dump valve for a tank, comprising in combination:
a liquid retaining tank having a bottom;
an outlet positioned on the bottom of the tank;
a valve seat on the outlet, the valve seat having inwardly tapered sidewalls, such that, as liquid flows through the outlet, debris in the tank tends to wash down the tapered sidewalls of the valve seat;
a valve member movable between a closed position engaging the valve seat and an open position spaced from the valve seat; and
an actuator to move the valve member between the closed position and the open position.

2. The dump valve as defined in claim 1, wherein the inwardly tapered sidewalls of the valve seat are at an angle of not less than 70 degrees and not more than 30 degrees.

3. The dump valve as defined in claim 1, wherein the valve member has inwardly tapered sidewalls which mate with the inwardly tapered sidewalls of the valve seat.

4. The dump valve as defined in claim 1, wherein the valve member has a truncated conical engagement surface.

5. The dump valve as defined in claim 1, wherein the valve member has a deformable engagement surface, that deforms to form a liquid retaining seal with the inwardly tapered sidewalls of the valve seat notwithstanding the presence of debris.

6. A dump valve for a tank, comprising:
a valve seat adapted to cover an outlet positioned on the bottom of a liquid retaining tank, the valve seat having inwardly tapered sidewalls, such that, as liquid flows through the outlet, debris in the tank tends to wash down the tapered sidewalls of the valve seat;
a valve member movable between a closed position engaging the valve seat and an open position spaced from the valve seat; and
an actuator to move the valve member between the closed position and the open position.

7. A dump valve for a tank, comprising in combination:
a liquid retaining tank having a bottom;
an outlet positioned on the bottom of the tank;
a valve seat on the outlet, the valve seat having inwardly tapered sidewalls, such that, as liquid flows through the outlet, debris in the tank tends to wash down the tapered sidewalls of the valve seat, the inwardly tapered sidewalls of the valve seat are at an angle of not less than 70 degree and not more than 30 degrees;
a valve member movable between a closed position engaging the valve seat and an open position spaced from the valve seat, the valve member having a deformable truncated conical engagement surface with inwardly tapered sidewalls which mate with the inwardly tapered sidewalls of the valve seat and deform to form a liquid retaining seal with the inwardly tapered sidewalls of the valve seat notwithstanding the presence of debris; and
a screw actuator to move the valve member between the closed position and the open position.
